(19) United States
(12) Patent Application Publication
(10) Pub. No.: US 2005/0044213 A1
(43) Pub. Date: Feb. 24, 2005

(54) Network traffic measurement system

(76) Inventors: Emiko Kobayashi, Yokohama (JP); Kiminori Sugauchi, Yokohama (JP); Minoru Koizumi, Tokyo (JP); Georg Carle, Tuebingen (DE); Tanja Zseby, Berlin (DE); Sebastian Zander, Berlin (DE); Carsten Schmoll, Berlin (DE); Lutz Mark, Berlin (DE); Guido Pohl, Berlin (DE); Jens Tiemann, Berlin (DE)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/853,158

(22) Filed: May 26, 2004

(30) Foreign Application Priority Data
May 26, 2003 (JP) 2003-147802

(51) Int. Cl. G06F 15/173

(52) U.S. Cl. 709/224

(57) ABSTRACT

A measurement system is provided. In that measurement system, an active measurement device and passive measurement devices can cooperate to perform flexible measurement. The measurement system comprises passive measurement devices, each of which receives packets flowing through a network and performs measurement according to a measurement rule; an active measurement device that sends a request for a measurement to a content providing server according to a measurement rule, and acquires information relating to contents as measurement objects based on a response to said request for a measurement; and an analysis device that derives characteristics relating to provision of the contents, by performing calculation according to an analysis rule, with said calculation using measurement results corresponding to the information acquired by said active measurement device among measurement results of said passive measurement devices.

### BACKGROUND OF THE INVENTION

The present invention relates to a measurement system for measuring traffic of a Web page consisting of a plurality of contents.

WWW (World Wide Web), which is a hypertext-type distributed information system using HTTP as its communication protocol, is a client/server type model. To access a document (a Web page) provided by a server, a client sends a request with a specified URL (Uniform Resource Locator) and the server responds to that request. A Web page is described generally using a language called HTML (HyperText Markup Language). HTML can incorporate not only texts but also data of various formats such as images and sound and link information to other documents.

As measurement of traffic characteristics in a client/server model, there may be mentioned passive measurement in which a measurement device is arranged within a network and captures data flowing through the network to measure delay times and the like, and active measurement in which a measurement device as a client sends a request to a server and receives a response to the request to measure a response time and the like.

As for the passive measurement at the IP level, measurement architecture is disclosed in RFC2722 of IETF. And, RFC2679 and 2680 show methods of measuring a delay time and a packet loss between two points.

As for the active measurement, U.S. Pat. No. 6,449,739 discloses a method in which an agent accesses a transaction server to measure a response time and the like, and U.S. Pat. No. 6,006,260 discloses a method in which a browser agent sends a request to measure a response time from a difference between the time of sending the request and the time of receiving a response.

Generally speaking, in many cases, a Web page consists of pieces of information (i.e., a plurality of contents) such as texts and images. In such a case, when a Web page is to be displayed, a request for each content is sent to a server in order that pieces of information to be displayed can be sequentially acquired from the server and incorporated into the Web page.

Thus, to measure traffic characteristics (such as a response time, a delay time, and the like) of a Web page, a response time, a delay time and the like should be acquired for each content as a constituent of the Web page.

In the case of measurement of traffic characteristics of a Web page consisting of a plurality of contents, it is possible in the conventional active measuring method to send a request to a server and to analyze a data part of a response to the request so as to acquire content information. Thus, it is possible to send a request for each content to acquire a response time for the Web page as a whole. However, in the active measuring method, it is difficult to measure, for example, a delay time, since packets should be captured at two points in a network.

On the other hand, in the passive measurement, it is possible to measure delay time or the like of a content by capturing at two points. However, to acquire content information of a Web page, data parts should be analyzed, and as a result a load of measurement of traffic characteristics of the Web page is large.

Thus, it is desired to realize a measurement system in which an active measurement device and a passive measurement device can cooperate with each other to flexibly perform measurement relating to a Web page.

Sometimes, for connection from a network on the side of a client to the Internet, a proxy server is provided to perform access control in order to ensure security and to reduce traffic. Generally, a proxy server has a cache function for a Web document. When information corresponding to a request exists in a cache, a proxy server sends the information existing in the cache to a client without sending the request to the Internet. Further, sometimes a network on the side of a server is provided with a reverse proxy in order to provide security such as prevention of unauthorized access. In both cases, a proxy server is a server that relays access, and can convert an IP address in order to separate a local network from the Internet. Further, in a reverse proxy, sometimes a URL on the server side is converted into a URL that is opened to the outside.

To measure a delay time, it is necessary to identify an HTTP flow measured at different points. Here, an HTTP flow means a series of HTTP packets ranging from a request of a content specified by a certain URL to a response to that request.

However, in the case where a relay device such as a proxy server or a reverse proxy converts an IP address or a URL, sometimes the same packet has different source IP address, different destination IP addresses, or different URLs depending on locations of measurement. Accordingly, identification of an HTTP flow is difficult.

Further, in the case where a reverse proxy converts an URL on the server side into a URL opened to the outside, sometimes a URL of a request is not same depending on locations of measurement. Further, owing to a cache function of a proxy server, sometimes a request is not sent to the Internet.

Thus, in the case where a relay device interposes, it becomes difficult to identify an HTTP flow acquired by a measurement device. It is desired to realize a measurement system that can flexibly cope with such a case.

### SUMMARY OF THE INVENTION

An object of the present invention is to provide a measurement system that can flexibly perform measurement by cooperation of an active measurement device and a passive measurement device.

To solve the above problem, a first mode of the present invention provides a measurement system comprising:
one or more passive measurement devices, each of which receives packets flowing through a network and performs measurement according to a measurement rule set for that measurement device;
an active measurement device that sends a request for a measurement to a content providing server according to a measurement rule set for said active measurement device, and acquires information relating to contents as measurement objects based on a response to said request for a measurement; and
an analysis device that derives characteristics relating to provision of the contents, by performing calculation according to an analysis rule set for said analysis device, with said calculation using measurement results corresponding to the information acquired by said active measurement device among measurement results of said passive measurement devices.

Further, to solve the above problem, a second mode of the present invention provides a network traffic measurement system comprising:
an active measurement device that sends a request for a measurement to a content providing server according to a measurement rule set for the active measurement device;
a relay device that is provided between said active measurement server and said content providing server, converts and relays information relating to communication;
a plurality of passive measurement devices, each of which receives packets flowing through a network and performs measurement according to a measurement rule for that passive measurement device; and
an analysis device that collects measurement results of said passive measurement devices, identifies a flow as an aggregate of related packets measured in each passive measurement device, and derives traffic characteristics of the network; wherein:
said analysis device acquires conversion record information that records conversion of the information relating to communication, and identifies a flow based on the acquired conversion record information.

Or, the second mode may be a network traffic measurement system comprising:
a relay device that is provided between a client and a content providing server, and converts and relays information relating to communication;
a plurality of passive measurement devices, each of which receives packets flowing through a network and performs measurement according to a measurement rule set for that passive measurement device; and
an analysis device that collects measurement results of said passive measurement devices, identifies a flow as an aggregate of related packets measured in each passive measurement device, and derives traffic characteristics of the network; wherein:
said analysis device acquires conversion record information that records conversion of the information relating to communication, and identifies a flow based on the acquired conversion record information.

### BRIEF DESCRIPTION OF THE DRAWINGS

FIG. 1 is a block diagram showing a network system according to a first embodiment of the present invention;

FIG. 2 is a functional block diagram showing a measurement configuration server in the first embodiment of the present invention;

FIG. 3 is a functional block diagram showing an active meter in the first embodiment of the present invention;

FIG. 4 is a functional block diagram showing a passive meter in the first embodiment of the present invention;

FIG. 5 is a functional block diagram showing an analysis server in the first embodiment of the present invention;

FIG. 6 is a diagram showing an example of a configuration of rule data that the analysis server of the first embodiment stores in a rule database;

FIG. 7 is a diagram showing an example of a configuration of measurement result data that the analysis server of the first embodiment stores in a measurement result database;

FIG. 8 is a flowchart for explaining collection of measurement data by the analysis server of the first embodiment of the present invention;

FIG. 9 is a sequence diagram of the system of the first embodiment of the present invention;

FIG. 10 is a sequence diagram of a system according to a first variation of the first embodiment of the present invention;

FIG. 11 is a sequence diagram of a system according to a second variation of the first embodiment of the present invention;

FIG. 12 is a diagram showing an example of a configuration of relay information data that an analysis server according to a second embodiment of the present invention stores in a measurement result database; and

FIG. 13 is a diagram showing contents of a measurement request that is received from a person in charge of measurement in the first embodiment of the present invention.

### DESCRIPTION OF THE PREFERRED EMBODIMENTS

Embodiments of the present invention will be described in detail referring to the drawings.

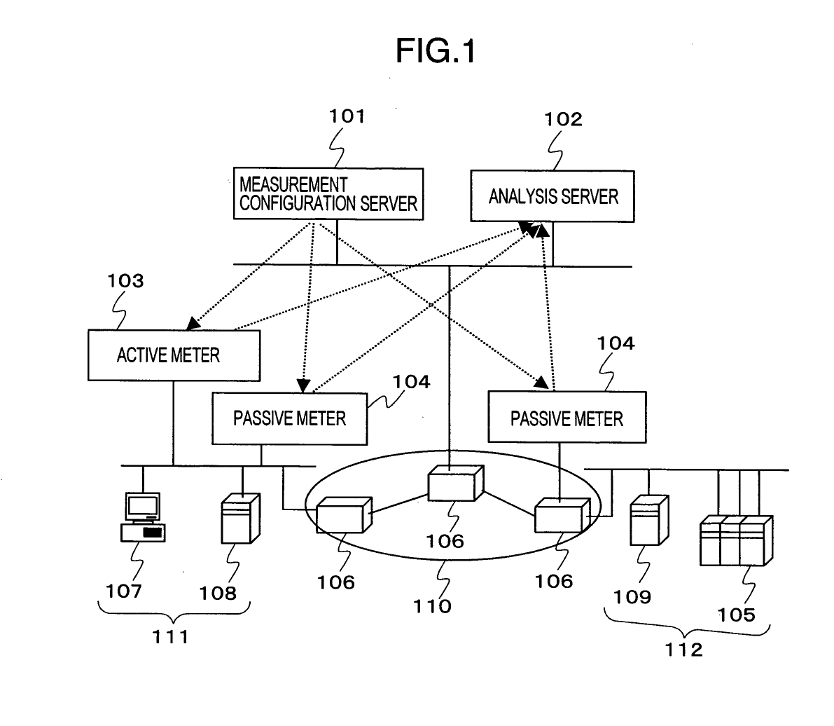

FIG. 1 is a diagram showing an example of a configuration of a network to which the present invention is applied.

In the figure, a server computer 105 functions as a Web server that provides contents, and a terminal device 107 functions as a Web client that enjoys the contents provided. A client side network 111 including the terminal device 107 is connected to a backbone network 110 comprising a plurality of network devices 106 such as routers. Further, a server side network 112 including the server computer 105 (hereinafter, referred to as the Web server 105) is connected to the backbone network 110. Thus, traffic between the client side network 111 and the server side network 112 is realized through the backbone network 110. Here, it does not matter whether each network is a wired network or a wireless network. Further, the server computer 105 may be a server computer group consisting of a plurality of computers. In the present embodiment, it is assumed that service provided by the Web server 105 is provision of We pages using HTTP, although the present invention is not limited to this.

In the present invention, traffic characteristics as service quality become objects of measurement. And, it is assumed that a person in charge of traffic measurement is, for example, a manager who manages or provides the backbone network 110. Of course, the present invention is not limited to this.

The client side network 111 is provided with a proxy server 108, and the server side network 112 is provided with the reverse proxy 109. However, each network configuration may be one without the proxy server 108 or the reverse proxy 109. First, for the sake of simplicity, the first embodiment will be described assuming that the proxy server 108 and the reverse proxy 109 do not perform such processing as conversion of an IP address and cache processing, or such processing does not affect results.

As shown in FIG. 1, an active meter 103 and passive meters 104 for performing passive measurement processing are arranged in the network. In the figure, one active meter 103 and one passive meter 104 are arranged in the client side network 111, and one passive meter 104 is arranged in the backbone network 110.

The number and locations of passive meters 104 depend on a network configuration, a measurement type, and the like. In the present embodiment where the traffic characteristics as the service quality are the objects of measurement, it is desirable that passive meters are located in the neighborhoods of connecting points between the backbone network 110 and other networks.

The active meter 103 and the passive meters 104 are given with respective identifiers. It is assumed that information such as an identifier, a location, an IP address and the like of each meter is known to the person in charge of the measurement.

The active meter 103 and the passive meters 104 can be implemented by software or hardware. Further, these meters may be incorporated into the network devices 106 or implemented as independent devices.

The network is further connected with a measurement configuration server 101 which receives a request relating to measurement of a traffic characteristic from the person in change of the measurement, and an analysis server 102 which makes an analysis based on measurement results collected by the active meter 103 and the passive meters 104. The measurement configuration server 101 and the analysis server 102 can be implemented by one or a plurality of ordinary information processing devices such as, for example, server computers. An ordinary information processing device comprising a processor, a storage unit, an input-output unit, and the like can function as the measurement configuration server 101 or the analysis server 102 by executing the below-mentioned programs for performing various kinds of processing. Of course, the measurement configuration server 101 or the analysis server 102 may be implemented as a dedicated device.

In the figure, the measurement configuration server 101 and the analysis server 102 exist in the same broadcast domain. However these servers 101 and 102 may exist in different broad cast domains from each other. Further, it does not matter where these servers are located on the network.

It is assumed that IP addresses and port numbers of the measurement configuration server 101 and the analysis server 102 are known to the person in charge of the measurement. Further, it is desirable to register these IP addresses and port numbers together with the identifier, the location, the IP address and the like of each meter, at the measurement configuration server 101.

In the present embodiment, when the measurement configuration server 101 receives a measurement request, the measurement configuration server 101 sends rules that define contents of processing to the active meter 103, the passive meters 104 and the analysis server 102. Then, the active meter 103 acquires configuration information of a Web page as the object of the measurement. And, the passive meters 104 capture data flowing through the network and extract the packets required. The analysis server 102 associates the Web page configuration with the packets extracted by the passive meters 104, and then calculates traffic characteristics.

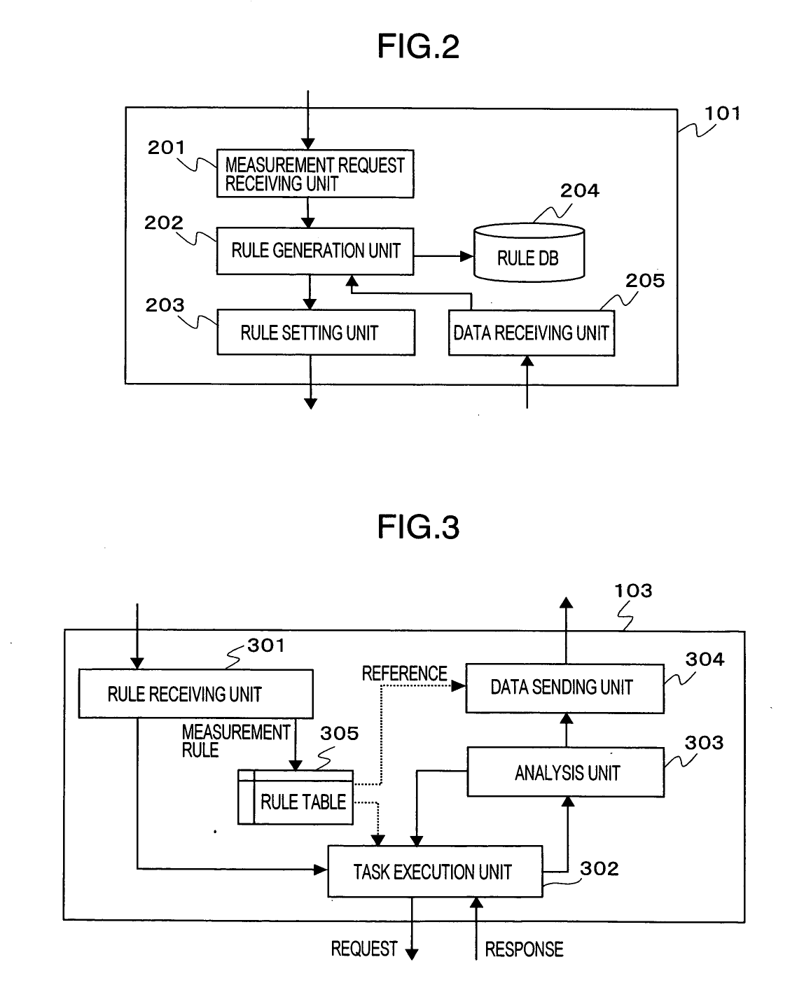

FIG. 2 is a block diagram showing a functional configuration of the measurement configuration server 101. A measurement request receiving unit 201 of the measurement configuration server 101 receives a measurement request from the person in charge of the measurement.

It is assumed that a measurement request includes items as shown in FIG. 13, for example.

In FIG. 13, the item “Measurement type” can be “delay time”, “packet loss”, “response time”, “availability”, or the like. The types “delay time” and “packet loss” respectively mean measurement of a packet transfer delay time and measurement of a packet loss, from a certain point to another point on the network (for example, from the neighborhood of the connecting point of the backbone network 110 to the server side network 112 to the neighborhood of the connecting point of the backbone network 110 to the client side network 111), and thus each is a type of measurement using at least two passive meters 106. Further, the type “response time” means measurement of, for example, a time between a start of a request for a certain Web page and display of the entire Web page, and the type “availability” means measurement of the ratio at which, for example, services of a certain Web page can be normally used. Thus, only one passive meter 106 is sufficient for each of these types. In any measurement type, it is assumed in the present embodiment that one active meter 103 is used for sending a request to the Web server 105 and acquiring a list of URLs included in a Web page used for measurement.

The item “Object Web page's URL” indicates a URL of a Web page that is used for measurement and provided by the Web server 105.

The item “Idéntifier of meter used for measurement” indicates an identifier of at least one active meter 103 and an identifier or identifiers of one or a plurality of passive meters 104, the number of which depends on the measurement type. The person in charge of measurement judges which meter should be used, based on the network configuration, for example.

The items “Start time” and “End time” indicate a start time and an end time of measurement.

The item “Report interval” means an interval of sending measurement results of the passive meters 104 in the case where a method of collecting measurement results is a push type, and an interval at which the analysis server 102 sends a collection request to collect measurement results in the case where a method of collecting measurement results is a pull type. Here, the push type means a method in which the passive meters 104 send results at regular intervals, and the pull type means a method in which the passive meters 104 send measurement results in response to a request from the analysis server 102.

These items may be set by the person in charge of measurement. Or, it is possible that the person in charge sets an outline of measurement, and the measurement configuration server 101 determines detailed contents according to predetermined rules.

In FIG. 2, based on the measurement request received by the measurement request receiving unit 201, a rule generation unit 202 of the measurement configuration server 101 generates rules that define processing to be performed by the active meter 103, the passive meters 104 and the analysis server 102.

In detail, the following processing is performed.

First, a request identifier is uniquely assigned to the received measurement request. Further, the rule generation unit 202 determines processing (referred to as a measurement task) to be performed by the active meter 103 and the passive meters 104 used for measurement and processing (referred to as an analysis task) to be performed by the analysis server 102, and generates rules (referred to measurement rules and analysis rule, respectively), and uniquely assigns task identifiers to respective rules.

The measurement rule for the active meter 103 designated in the measurement request includes the request identifier, the task identifier, the URL of the object Web page, the start time, and the address and port of the analysis server 102. In the present embodiment, the processing performed by the active meter 103 is to send a request to the URL of the object Web page and to acquire URL structure of the Web page, and accordingly, the start time can be that instant.

The measurement rule for each of the passive meters 104 designated in the measurement request includes the task identifier, filtering conditions, the measurement type (“delay time”, “response time”, “availability”, or the like), the start time, and the end time, and in the case where the collection method is the push type, the address and port number of the analysis server, and the report interval.

The filtering conditions designate conditions for selecting captured packets. For example, the filtering conditions designate HTTP as a protocol type, the IP address of the active meter 103 as the source, the IP address of the Web server 105 as the destination, and the like. In the case of measurement of HTTP traffic, when, for example, HTTP is designated in the protocol type of the filtering conditions and the other conditions are not designated, then entire traffics relating to HTTP are measured.

The analysis rule for the analysis server 102 includes the request identifier, the URL of the object Web page, the measurement type, the start time, the end time, the report interval in the case where the collection method is the pull type, and further, the identifier, the address and the port number of the active meter 103, the task identifier to the active meter 103, and the identifier, the address and the port number of each passive meter 104, and the task identifier to each passive meter 104.

The rule generation unit 202 of the measurement configuration server 101 registers the generated measurement rules and analysis rule to a rule database 204, and at the same time notifies a rule setting unit 203 of these rules.

The rule setting unit 203 notifies the active meter 103, the passive meters 104 and the analysis server 102 of the corresponding measurement rules and analysis rule notified from the rule generation unit 202.

The measurement configuration server 101 is provided with a data receiving unit 205 for receiving data other than a measurement request. Further, the measurement configuration server 101 receives not only a request for starting measurement but also a request for termination, change, or the like of measurement from a user, although description is omitted.

FIG. 3 is a block diagram showing a functional configuration of the active meter 103. In the figure, a rule receiving unit 301 receives the measurement rule sent from the measurement configuration server 101. The received measurement rule is registered into a rule table 305, and notified to a task execution unit 302. The task execution unit 302 sends a request for a measurement to the object Web page's URL included in the measurement rule, and receives a response from the Web server 105.

A message body part (an HTML file) of the received response is sent to an analysis unit 303. The analysis unit 303 extracts content information (for example, predetermined tag information) included in the object Web page from the HTML file, and generates a list of URLs constituting the Web page. For management of the generated URL list, the task identifier is added to the list. At that time, in the case where the object Web page includes a script file and, within the script, a request is to be sent to a certain URL, the task execution unit 301 is entrusted with sending of the request to that URL, and processing similar to the above is performed with respect to a response to that request. In the case where a plurality of requests are sent to a same URL, then results corresponding to the plurality of requests are recorded in the resultant list.

A data sending unit 304 sends the generated URL list as a measurement result to the analysis server designated in the measurement rule.

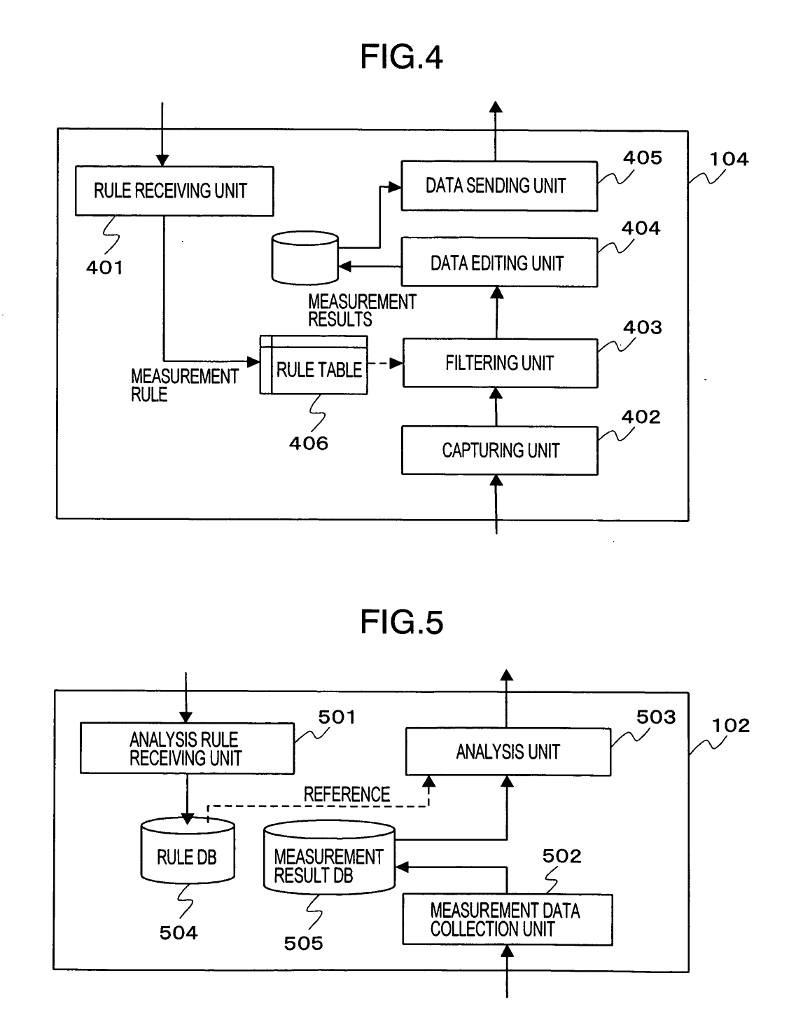

FIG. 4 is a block diagram showing a functional configuration of a passive meter 104. A rule receiving unit 401 receives the measurement rule sent from the measurement configuration server 101. The received measurement rule is registered into a rule table 406.

According to the measurement rule, a capturing unit 402 captures packets from the network from the start time through the end time, and affixes a time stamp to those packets.

A filtering unit 403 selects packets that satisfy the filtering conditions out of the captured packets.

A data editing unit 404 processes the selected packets if necessary, and stores the processed result and the like as HTTP flow information together with the task identifier onto the storage unit. As the processing, may be mentioned acquisition of the first and last response times in the case of a plurality of response packets, or may be mentioned judgment of a response status (i.e., normal or error) from the response condition, or acquisition of a content size.

A data sending unit 405 sends the stored measurement result to the analysis server 102 at each point of time determined by the report interval in the case where the push type is designate, or at a point of time when the analysis server 102 makes a request in the case where the pull type is designated.

A passive meter 104 is adapted for various protocols, and can perform measurement relating to TCP and UDP of the transport layer and DNS and HTTP of the upper layers.

FIG. 5 is a block diagram showing a functional configuration of the analysis server 102. An analysis rule receiving unit 501 receives the analysis rule sent from the measurement configuration server 101, and registers the received analysis rule into a rule database 504. A measurement data collection unit 502 receives the measurement results sent from the active meter 103 and the passive meters 104 used for the measurement, and registers the received measurement results into a measurement result database 505. An analysis unit 503 performs calculation processing corresponding to the measurement type such as “delay time”, according to the analysis rule and using the received measurement results, i.e., the URL lists and measurement data.

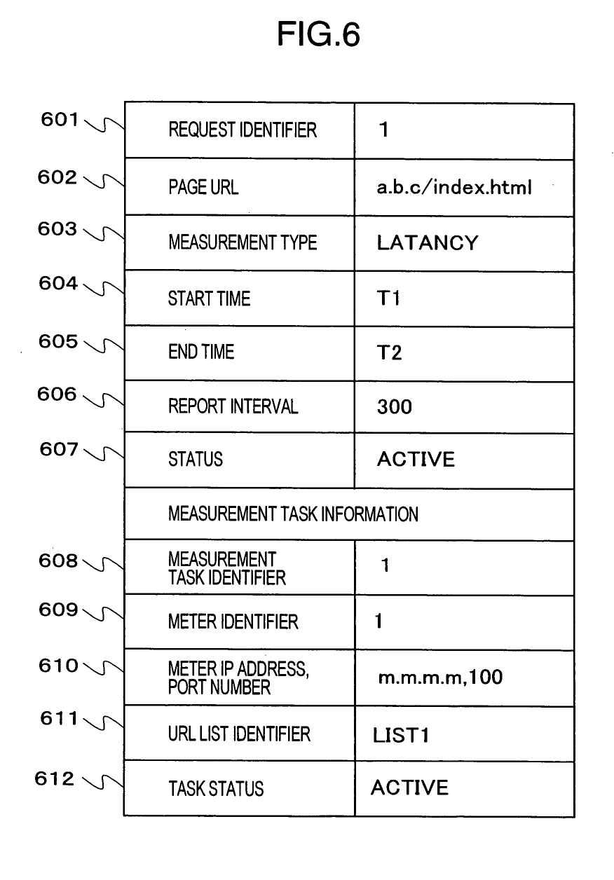

FIG. 6 shows an example of a data configuration of the rule database 504. The rule database 504 manages a request identifier 601, an object Web page's URL 602, a measurement type 603, a start time 604, an end time 605, a report interval 606 and a status 607, as measurement request-based information. The status 607 indicates a status of processing according to the measurement request concerned, and takes one of values, “INITIAL” (an initial state), “ACTIVE” (the analysis processing in progress), “DONE” (a state of a normal end of the analysis processing) and “ERROR” (a state of an abnormal end), for example.

Further, as measurement task information, the rule database 504 manages information of the associated measurement rules executed by meters corresponding to a measurement request.

Measurement task information consists of a measurement task identifier 608, an identifier 609 of a passive meter 104, and an IP address and a port number 610 of that passive meter 104, an identifier 611 of a URL list as a measurement result of the active meter 103 for the measurement request concerned, and a task status 612 indicating a status of the measurement task. In the case of a measurement type using a plurality of passive meters 104, the measurement task information is managed for each passive meter 104 being associated with the above-mentioned measurement request-based information.

The measurement request-based information and the measurement task identifier 608 and the information 609, 610 on the passive meter in the measurement task information are set by the analysis rule receiving unit 501 at the time of receiving the analysis rule. The task status 612 is set with one of values, “INITIAL” (an initial state before execution of the measurement task), “ACTIVE” (the task is in progress), “DONE” (a state of a normal end of the task) and “ERROR” (a sate of an abnormal end of the task), for example, according to the state of the measurement task. The URL list identifier 611 is arbitrarily set by the measurement data collection unit 502 after receiving the URL list as the measurement result from the active meter 103.

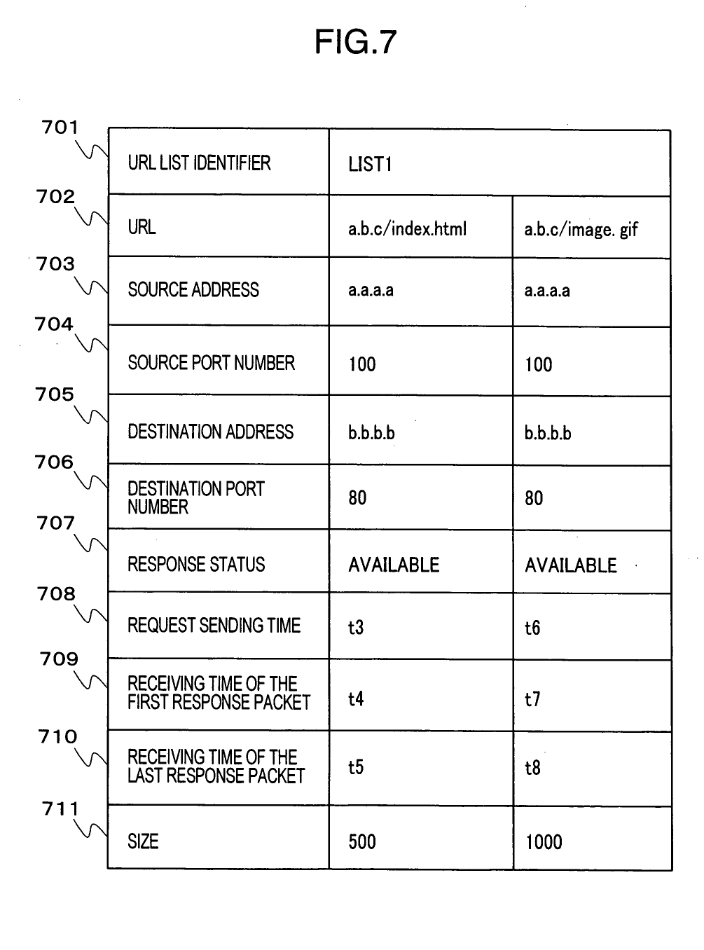

FIG. 7 shows an example of a data configuration of the measurement result database 505. The measurement result database 505 consists of a URL list identifier 701 for identifying a measurement result acquired based on a measurement request, a URL 702 for registering a URL included in the URL list, an IP address 703 and a port number 704 of a client as a source of the request, an IP address 705 and a port number 706 of a server as a destination of the request, a response status 707, a request sending time 708, a first response receiving time 709 and a last response receiving time 710 as measurement time information, and a size 711. The URL list identifier 701 corresponds to the URL list identifier 611 registered in the rule database 504 and associates the measurement result with the analysis rule.

The analysis rule receiving unit 501 of the analysis server 102 receives the analysis rule from the measurement configuration server 101, and the received analysis rule is registered into the rule database 504. Here, the status 607 and the task status 612 of each measurement task are “INITIAL”.

At the start time, the analysis server 102 starts to receive measurement results at the measurement data collection unit 502, and sets the status 607 to “ACTIVE”. Further, at a point of time when a measurement result is received from a passive meter 104, the task status 612 of the corresponding measurement task information is set to “ACTIVE”.

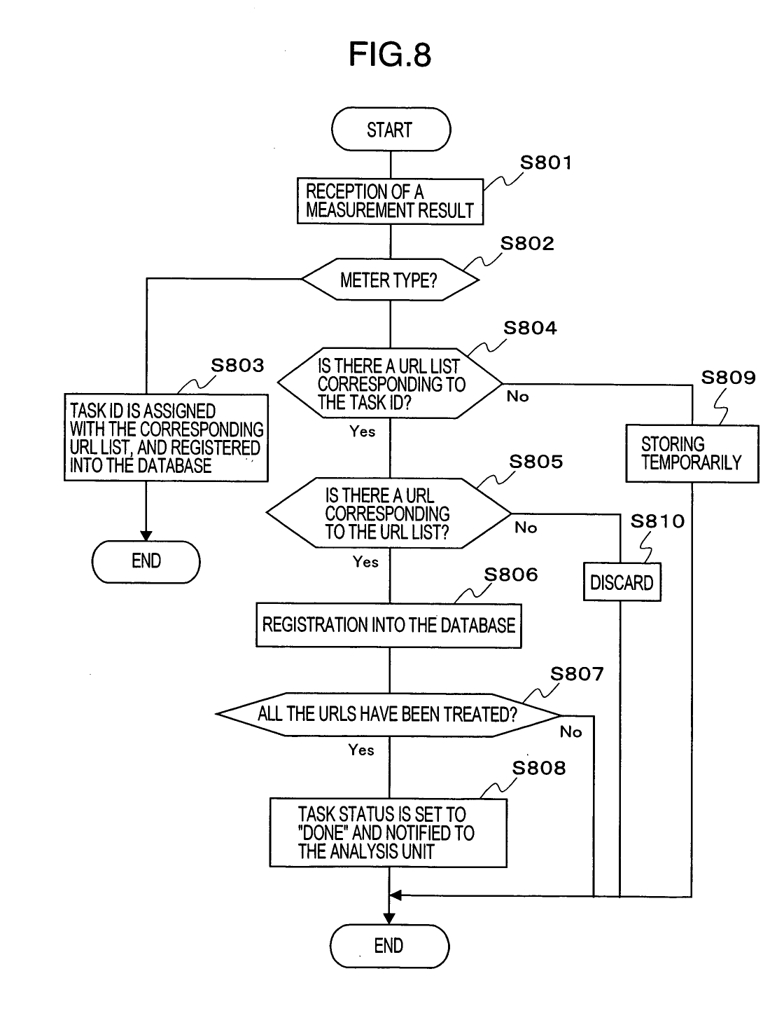

Next, referring to a flowchart of FIG. 8, will be described processing in the measurement data collection unit 502 of the analysis server 102.

When the measurement data collection unit 502 receives a measurement result in the step S801, the measurement data collection unit 502 judges whether the measurement result is sent from the active meter 103 or a passive meter 104 (S802).

In the case where the measurement result is sent from the active meter 103, then the URL lists as the measurement results are added with identifiers, and the measurement data collection unit 502 registers new records into the measurement result database 505 (S803). Referring the rule database 504, the number of the new records to be registered corresponds to the number of pieces of measurement task information, i.e., the number of the passive meters 104 used for the measurement. Also, the number of the above-mentioned URL list identifiers corresponds to the number of the pieces of measurement task information, and a unique URL list identifier is given to each passive meter 104 used for the measurement.

The URL list identifier 701 of a new record is registered with the given URL list identifier, and each URL 702 is registered with a URL included in the URL list. The URL list identifier is also registered into the URL list identifier 611 of the corresponding measurement task information in the rule database 504. Here, the URL 702 of the measurement result database 505 registers the URL of the Web page in question and all the URLs of the contents constituting the Web page. For example, in the case where a Web page specified by an HTML file “index.html” includes image data “image.gif”, then, in the measurement result data base 505, two URLs 702 are registered for one URL list identifier 701.

On the other hand, in the case where the measurement result is sent from a passive meter 104, then, based on the task identifier included in the received measurement result, it is examined referring to the rule database 504 whether the URL list identifier 611 has been registered, in other words, whether a record for storing the measurement result has been registered in the measurement result database 505 (S804).

In the case where the URL list identifier 611 has not been registered, then the measurement result is temporarily stored in the storage unit (S809). And thereafter, when another measurement result is received, the search is performed again. This operation is performed considering the case where the measurement result from the passive meter 104 is received earlier among the measurement results relating to the same measurement request.

In the case where the URL list identifier 611 has been registered, then it is judged whether, among the URLs 702 registered in the corresponding measurement result database 505, there exists a URL 702 coincident with the URL information included in the received measurement result (S805).

As a result, in the case where there does not exist a URL 702 coincident with the URL information, then the measurement result is discarded (S810).

On the other hand, in the case where there exists a URL 702 coincident with the URL information, then address information such as the source IP address and the destination IP address, the request sending time, the HTTP flow information such as the content size included in the received measurement result are registered into the measurement result database 505 respectively at the address information 703, 704, 705 and 706, the response status 707, the time information 708, 709 and 710 and the size 711 corresponding to the coincident URL 702 (S806).

After the registration of the result, it is judged whether measurement results have been collected from the passive meter 104 with respect to all the URLs registered in the URL 702 (S807). In the case where results have been collected with respect to all the URLs, then it is judged that the measurement task has been ended, and the task status 612 in the rule database 504 is set to “DONE”, and the end of the measurement task is notified to the analysis unit 503 (S808). In the case where results for all the URLs can not be collected even after the elapse of a predetermined time, the task status 612 is set to “ERROR” and the end of the measurement task is notified to the analysis unit 503.

After the analysis unit 503 receives a notification of an end of each measurement task for the request identifier, or after the elapse of a predetermined time from the end time, the analysis unit 503 looks into the status of the measurement task to examine whether the measurement task has been ended normally. In the case of the normal end, the status 607 of the rule is set to “DONE”. And, based on the measurement type 603 of the rule database 504, the analysis unit 503 analyzes the measurement result. The analysis result is sent to an upper application or the like that uses the analysis result of the analysis server 102.

As the analysis processing of the analysis unit 503, the following is mentioned. For example, as for HTTP in the case where the measurement type is “response time (LATENCY)”, the analysis unit 503 calculates a difference (server's LATENCY) between the request sending time and the receiving time of the first response packet, a difference (a download time) between the receiving times of the first and last response packets, and the sum of those times as the total time of HTTP. Further, it is possible to acquire results of measurement of times required for processing DNS and establishing TCP connection relating to HTTP from a passive meter 104, and to calculate the total LATENCY for an object URL based on the acquired measurement results together with the time information relating to HTTP.

Further, LATENCY for the entire Web page can be calculated as a difference between the start time of the first DNS and the receiving time of the last response packet for all the URLs, or by adding LATENCYs of all the URLs constituting the page.

In the case where the response status 707 is “ERROR” and the processing indicated by the measurement type can not be performed, or in the case where there exists an abnormally-ended task, then, the status 607 of the rule database 504 is set to “ERROR” and the analysis processing in the analysis unit 503 is not performed, and the error is notified to the upper application.

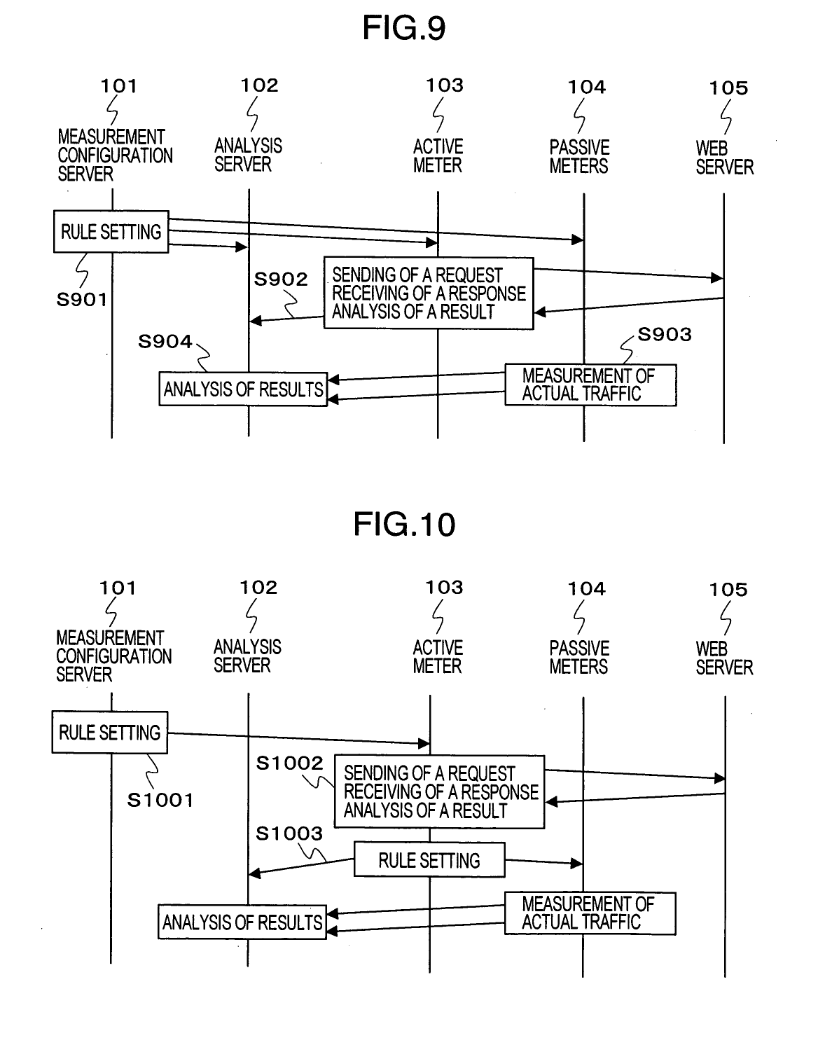

FIG. 9 is a sequence diagram of the system as a whole. First, the measurement configuration server 101 generates rules based on a measurement request, and sends the analysis rule to the analysis server 102 and the respective measurement rules to the active meter 103 and the passive meters 104 (S901).

Based on the measurement rule, the active meter 103 sends a request for a measurement to the Web server 105. And, based on a response to the request, the active meter 103 generates a URL list and sends the generated URL list to the analysis server 102 (S902).

Each of the passive meters 104 performs measurement according to its measurement rule, and sends a measurement result to the analysis server 102 (S903).

In the analysis server 102, the URL list as the measurement result of the active meter 103 is registered into the measurement result database 505, being associated with the measurement results of the passive meters 104, and the analysis is performed according to the measurement type indicated in the analysis rule (S904).

As described above, it is possible to realize a measurement system in which an active measurement device and passive measurement devices cooperate to perform flexible measurement considering a Web page configuration.

Next, will be described a first variation of the above embodiment. FIG. 10 is a sequence diagram of a system as a whole in the first variation.

Differences from FIG. 9 are as follows. Namely, the measurement configuration server 101 sends a measurement rule to the active meter 103 only (S1001). The active meter 103 sends a request for a measurement to the Web server 105, and receives a response to analyze a Web page (S1002). Based on the analysis result, the active meter 103 generates measurement rules to be used by the passive meters 104 and notifies the passive meters 104 of the respective measurement rules. Further, the active meter 103 generates a measurement rule to be used by the analysis server 102 and notifies the analysis server 102 of the measurement rule (S1003). Functional configurations of the servers and the meters can be similar to the respective ones of the above embodiment.

Now, will be described a processing flow in the first variation.

After receiving a measurement request from a person in charge of measurement, the measurement configuration server 101 sends a measurement rule to the active meter 103 only, without sending measurement rules to the passive meters 104 and the analysis server 102.

In this case, the measurement rule includes the following items in addition to a request identifier, a task identifier, a URL of an object Web page, a start time, and an address and a port number of the analysis server 102, namely identifiers, addresses and port numbers of the passive meters 104 used, and the items included in the measurement rules to a passive meter 104 in the above embodiment, i.e., a measurement type, a report interval, filtering conditions used by the passive meters 104, and respective task identifiers of the meters and the analysis server.

The rule receiving unit 301 of the active meter 103 receives the measurement rule sent from the measurement configuration server 101. The received measurement rule is registered into the rule table 305, and notified to the task execution unit 302. The task execution unit 302 sends a request for a measurement to the object Web page's URL included in the measurement rule, and receives a response from the Web server 105.

A message body part (an HTML file) of the received response is sent to the analysis unit 303. The analysis unit 303 extracts information on contents included in the object Web page from the HTML file and generates a list (a URL list). The generated URL list is added with a task identifier and sent by the data sending unit 304 to the passive meters 104. Here, the data sending unit 304 refers to the rule table 305, and sends measurement rules and an analysis rule to the passive meters 104 and the analysis server 102, respectively.

The contents of the measurement rule sent to a passive meter 104 are the contents of the first embodiment added with (as filtering conditions) all the URLs included in the generated URL list.

Further, the contents of the analysis rule sent to the analysis server 102 are based on the measurement rule received from the measurement configuration server 101 and can be similar to the above embodiment.

The rule receiving unit 401 of each passive meter 104 receives the measurement rule sent from the active meter 103. In the present embodiment, as filtering conditions, URLs are designated in addition to a source IP address and a destination IP address. The filtering unit 403 performs filtering according to the filtering conditions, and sends a measurement result to the analysis server 102.

In the analysis server 102, when the measurement data collection unit 502 starts to collect measurement data from a passive meter 104, each piece of measurement task information is assigned with a measurement result database 505, set with a URL list identifier 701, and registers a measurement result corresponding to a URL 702 into the measurement result database 505.

The active meter 103 may notify the passive meters 104 of the measurement result as filtering conditions, and send the URL list to the analysis server 102 similarly to the above embodiment. In that case, when the analysis server 102 receives the URL list from the active meter 103, the analysis server 102 assigns a measurement result database 505 to each measurement task and registers the information of the URL list into each measurement result database 505. Thereafter, the analysis server 102 registers a measurement result from a passive meter 104 into the corresponding measurement result database 505.

Thus, according to the first variation, in addition to the effects of the above-described first embodiment, it is possible that a passive meter 104 narrows down URLs that become the objects and thereafter performs filtering. As a result, data quantity of a measurement result is reduced and the load on the network is reduced. Additionally, the load of the analysis processing in the analysis server 102 can be reduced.

Next, will be described a second variation of the above embodiment.

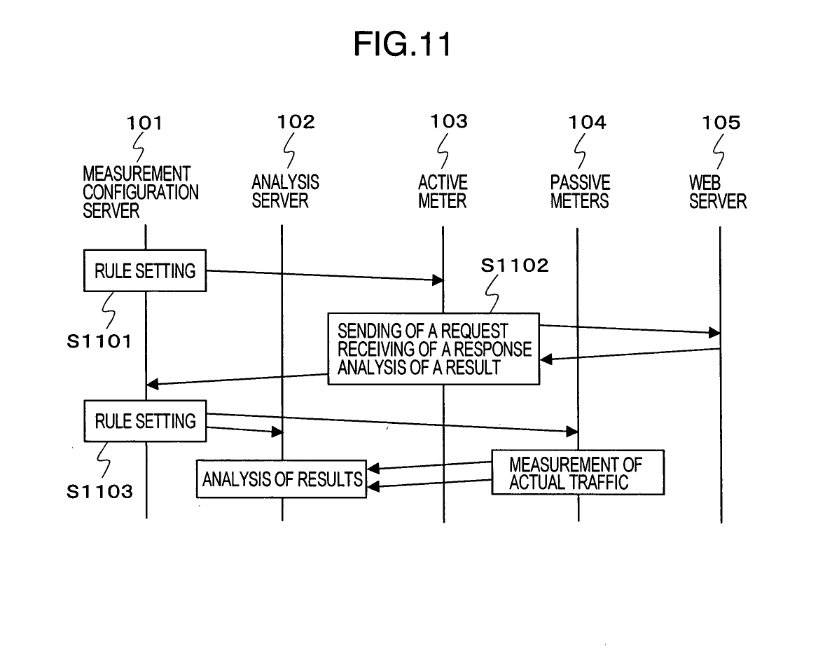

FIG. 11 is a diagram showing a sequence of an entire system in the second variation. Differences from FIG. 9 are as follows. Namely, the measurement configuration server 101 sends a measurement rule to the active meter 103 only (S1101). The active meter 103 sends a URL list as a result of execution of a measurement task to the measurement configuration server 101 (S1102). Thereafter, the measurement configuration server 101 generates measurement rules and an analysis rule including the information of the URL list to the passive meters 104 and the analysis server 102, respectively (S1103).

Now, will be described a processing flow in the second variation.

After receiving a measurement request from a person in charge of measurement, the measurement configuration server 101 sends a measurement rule to the active meter 103, first of all.

The active meter 103 registers the measurement rule received from the measurement configuration server 101 into the rule table 305, and sends a request for a measurement according to the measurement rule, and receives a response. The analysis unit 303 of the active meter 103 generates a URL list and the data sending unit 304 sends the URL list as a measurement result to the measurement configuration server 101.

The receiving unit 205 of the measurement configuration server 101 receives the measurement result from the active meter 103, and notifies the rule generation unit 202 of the measurement result. Based on the measurement request from the person in charge of the measurement, the rule generation unit 202 generates rules that determine processing to be performed by the passive meters 104 and the analysis server 102. Here, similarly to the first variation, the filtering conditions included in the rule for a passive meter 104 are ones added with all the URLs included in the generated URL list. The rule for the analysis server 102 is similar to the first embodiment.

The rule setting unit 203 sends the rules to the passive meters 104 and the analysis server 102, as measurement rules and an analysis rule, respectively.

The contents of the notification to the analysis server 102 are similar to the first embodiment, while the contents of the notification to a passive meter 104 are ones added with all the URLs of the result, as filtering conditions.

Similarly to the first variation, the rule receiving unit 401 of each passive meter 104 receives the measurement rule sent from the measurement configuration server 101. According to the filtering conditions with the designated URLs, the filtering unit 403 performs filtering of packets and sends a measurement result to the analysis server 102.

When the measurement data collection unit 502 of the analysis server 102 starts to collect measurement data from a passive meter 104, then the analysis server 102 assigns a measurement result database 505 to each piece of measurement task information, sets a URL list identifier 701, and registers a measurement result corresponding to each URL 702 into the measurement result database 505.

The active meter 103 may notify the passive meters 104 of the measurement result as filtering conditions, and similarly to the above embodiment, send the URL list to the analysis server 102. In that case, when the analysis server 102 receives the URL list from the active meter 103, the analysis server 102 assigns a measurement result database 505 to each measurement task, and registers the information of the URL list into each measurement result database 505. Thereafter, the analysis sever 102 registers a measurement result from a passive meter 104 into the corresponding measurement result database 505.

Thus, according to the second variation, in addition to the effects of the above-described first embodiment, it is possible that a passive meter 104 narrows down URLs that become the objects and thereafter performs filtering. As a result, data quantity of a measurement result is reduced and the load on the network is reduced. Additionally, the load of the analysis processing in the analysis server 102 can be reduced.

Next, will be described a third variation of the above embodiment, wherein information included in a header part of HTTP is used. This uses Referer attribute of a request of HTTP. A Web client sets information of a URL that calls a URL in question to Referer attribute. For example, in the case of a request for a content in a Web page, Referer attribute of this request is set with the page URL. It is not necessary that all the clients set this information, and some clients as objects of measurement do not set this information. Here, description will be given assuming that this information is set.

Only when a request is received, a passive meter 104 registers the information of Referer attribute included in the header part of the request when the data editing unit 404 of the passive meter 104 registers the measurement result.

In the analysis server 102, when a measurement result is received from a passive meter 104 while the measurement data collection unit 502 has not collected a result from the active meter 103, then in the case where the received measurement result includes Referer attribute, it is judged whether the measurement task identifier and the Referer attribute information coincide with the page URL. In the case of coincidence, the URL is added as a URL 702 of the measurement result database 505 corresponding to the measurement task identifier, and the measurement result is registered into the measurement result database 505.

Whether results of all the contents constituting a Web page has been collected is judged as follows. Namely, in the case where a measurement result of a measurement task concerned has not been received from a passive meters 104 for a predetermined period, then it is judged that all the results have been collected, and the measurement task is ended. The ended measurement task is notified to the analysis unit 503, and the analysis unit 503 analyzes the results.

As described above, using Referer attribute, it is possible to perform measurement relating to a Web page and contents constituting the Web page.

Next, will be described a second embodiment according to the present invention. In the present embodiment, will be described the case where a delay time in traffic through a gateway such as a proxy server 108 is measured by passive meters placed at two or more locations.

A network configuration in the present embodiment is similar to the configuration shown in FIG. 1. However, in relation to the proxy server 108, a passive meter 104 of the client side network 111 is located on the side of a Web client such as the active meter 103 or a Web browser. Further, another passive meter 104 is located at the server side network 112 that is on the side of the Web server 105 in relation to the backbone network 110 or the reverse proxy 109. In particular, the present embodiment considers processing in the proxy server 108 connected to the client side network 111 and processing in the reverse proxy 109 connected to the server side network 112.

When the proxy server 108 receives a request from a client such as the active meter or a Web browser, the proxy server 108 judges whether the data concerned exist in the cache. In the case where the data concerned do not exist in the cache, the proxy server 108 transfers the request to the reverse proxy 109 through the backbone network 110.

First, mainly differences from the first embodiment will be described with respect to the case where the proxy server 108 transfers request in the order of receiving from a client and the reverse proxy 109 does not converts URLs.

Similarly to the first embodiment, the measurement configuration server 101 sets measurement rules for the passive meters 104. Further, in addition to the contents of the analysis rule of the first embodiment, the analysis server 102 is notified of IP addresses and port numbers of relay devices (here, the proxy server 106 and the reverse proxy 109) as components of the network. Here it is assumed that the IP addresses and the port numbers of the relay devices are known and held in advance, for example, by the measurement configuration server 101.

Each passive meter 104 performs measurement relating to a request to each URL and a response to that request, and sends a result to the analysis server 102.

In the analysis server 102, when the received analysis rule includes information (such as the IP addresses) of the relay devices, then the information also is registered into the rule database 504. Based on results recorded in the measurement result database 506, the analysis unit 503 calculates a delay time, which is the measurement type of this embodiment.

In calculation of a delay time, first a URL list identifier 611 is extracted from the data corresponding to the measurement task identifier 608 registered in the rule database 504. The extracted URL list identifier is used as a key for extracting the corresponding HTTP flow information from the measurement result database 505. The HTTP flow information is measurement results of a plurality of passive meters 104 used for the measurement. For each URL, the analysis unit 503 compares the HTTP flow information measured by each passive meter 104 to identify an HTTP flow, and calculates a delay time from a time difference of the identified HTTP flow.

Here, the measurement result from the passive meter 104 located at the client side network 111 passes through the proxy server 108 (since, as described above, in the present embodiment, the passive meter 104 on the client side network 111 is located on the side of a client such as the active meter or a Web browser, in relation to the proxy server 108). Thus, the source is defined by the IP address and the port number of the client, and the destination is defined by the IP address and the port number of the proxy server 108. Further in the case of a measurement result from the passive meter 104 located at the backbone network 110, the source is defined by the IP address and the port number of the proxy server 108 and the destination is defined by the IP address and the port number of the server. Thus, although for the same HTTP flow, both results do not coincide.

Accordingly, for identification of an HTTP flow, the analysis server 102 uses URLs and times as comparison conditions. The analysis unit 503 compares respective URLs 702 in the data of measurement results received from the passive meters 104, to extract a same URL. In the case where no other entry has the same URL 702, it is judged that the data belong to the same HTTP flow. In the case where a plurality of entries have a same URL 702, then, referring to the request sending times 708, the order of sending the requests in the passive meters 104 is judged to identify a same HTTP flow.

For an HTTP flow that is judged to be same for the passive meters 104, a difference is calculated from the request sending times 708 or the first response packet receiving times 709 or the last response packet receiving times 710 in the measurement results, to obtain a delay time.

Next, will be described the case where a relay device changes the sending order of requests. In that case, the analysis server 102 acquires information on relaying, from the proxy server 108.

When the proxy server 108 receives a request from the active server 103, a Web browser or the like, the proxy server 108 records relay information of the request. The proxy server 108 periodically sends relay information to the analysis server 102. Similarly to a measurement result from a passive meter 104 or the like, the analysis server 102 receives the relay information at the measurement data collection unit 502, and records the received relay information into the measurement result database 505.

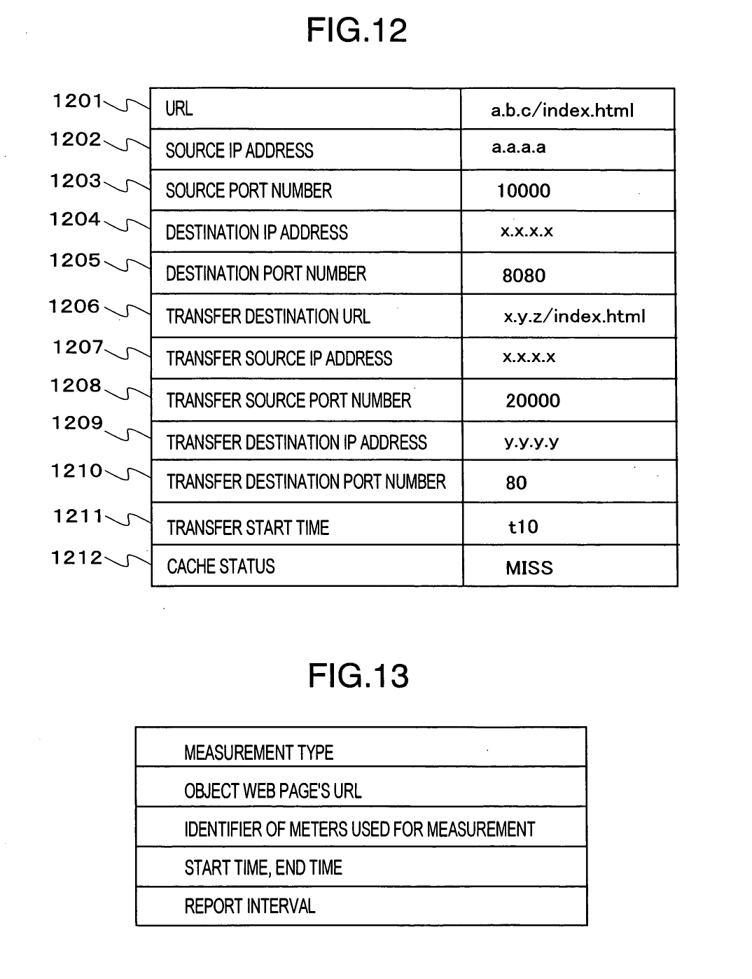

FIG. 12 shows an example of a data configuration of relay information recorded in the measurement result database 505. As shown in the figure, relay information consists of: a URL 1201; a source IP address 1202 and a source port number 1203 of the request; and a destination IP address 1204 and a destination port number 1205 as information acquired from a received request; and in the case of transferring the request, a transfer destination URL 1206, a transfer source IP address 1207 and a transfer source port number 1208, a transfer destination IP address 1209 and a transfer destination port number 1210, as information on the transferred request; a transfer time 1211, i.e., a time of sending the request; and a cache status 1212.

For identification of an HTTP flow, the analysis unit 503 uses URLs and times as comparison conditions. However, in the case where the proxy server 108 changes the order of sending requests, it is not possible to identify HTTP flows for a same URL.

Accordingly, IP addresses and port numbers are converted based on the relay information, before making a comparison. As for an HTTP flow that is an object of the measurement result acquired from the passive meter 104 of the client side network 111, when the destination is the proxy server 108, then, referring to the relay information of the proxy server 108, which is registered in the measurement result database 505, data coincident in the URL 1201, the source IP address 1202 and port number 1203 are extracted. Then, the source IP address 703 and port number 704 in the measurement result are converted into the transfer source IP address 1207 and port number 1208 extracted from the relay information. Further, the destination IP address 705 and port number 706 are converted into the transfer destination IP address 1209 and port number 1210 extracted from the relay information. Thereafter, the converted measurement result is compared with the measurement result of the passive meter 104 located in the neighborhood of the relay point between the backbone network 110 and the server side network 111. Then, HTTP flows coincident in all of the URL, the IP addresses and port numbers of the source and the destination are judged to be the same HTTP flow, and a delay time is calculated for that HTTP flow.

Further, in the case where the proxy server 108 sends a plurality of requests having the same URL to the same transfer destination thorough the same port in a short period, then measurement results in the backbone network 110 includes a plurality of measurements having the same URL, the same IP addresses, and the same port numbers.

In that case, the order of the requests is judged from the transfer times in the relay information of the proxy server 108, to identify the same HTTP flows.

Next, will be described the case where a relay device performs conversion of a URL.

It is assumed that the passive meter 104 of the client side network 111 is located on the side of a client such as the active meter 103 in relation to the proxy server 180, and the passive meter 104 of the server side network 112 is located on the side of the Web server 105 in relation to the reverse proxy 109.

Further, it is assumed that a plurality of servers exist in the server side network 112 and the reverse proxy 109 transfers a request to each server, and at that time, changes the URL if necessary.

Here, as for a measurement result from the passive meter 104 of the client side network 111, packets pass through the proxy server 108, and thus, the destination is set by the IP address and port number of the proxy server 108. Further, as for a measurement result from the passive meter 104 of the server side network 112, packets pass through the reverse proxy 109, and thus, the source is set by the IP address and port number of the reverse proxy 109. Also as for the URL, in the case where a URL in the server side network 111 is change from a URL opened to the outside, the reverse proxy 109 converts the URL, and the URLs become different.

In that case, the analysis server 102 acquires information on relay, from the proxy server 108 and the reverse proxy 109.

Similarly to the proxy server 108 in the above-described case where a relay device changes the order of sending requests, when the reverse proxy 109 receives a request, the reverse proxy 109 records relay information of the request, and sends relay information periodically to the analysis server 102. The analysis server 102 receives relay information at the measurement data collection unit 502, and records the received relay information into the measurement result database 505. A data configuration of relay information can be similar to FIG. 12.

The analysis server 102 uses relay information from the proxy server 108 and the reverse proxy 109 to convert the URL, the IP addresses and the port numbers in measurement results, and thereafter, compares them for identification of an HTTP flow.

The analysis unit 503 extracts an HTTP flow as the object of analysis, which is measured by the passive meter 104 of the client side network 111. In the case where the destination of the HTTP flow is the proxy server 108, then, referring to the relay information of this proxy server 108, which is registered in the measurement result database 505, the analysis unit 503 searches for entries coincident in the URL 1201, the source IP address 1202 and port number 1203.

In the case where there exist a pair of entries coincident in those conditions, and there is no other coincident entry, then the relay information in those entries is extracted. And, the source IP address 703 and port number 704 in a measurement result are replaced with the transfer source IP address 1207 and port number 1208 in the extracted relay information, and the destination IP address 705 and port number 706 are replaced with the transfer destination IP address 1209 and port number 1210 in the extracted relay information. Also, the URL 702 is replaced with the transfer destination URL 1206.

Further, in the case where the transfer destination is the reverse proxy 109, then, referring to relay information of the reverse proxy 109, the analysis unit 503 searches for entries coincident in the URL and the source IP address and port number.

In the case where there exist a pair of entries coincident in those conditions and there is no other coincident entry, then, the relay information in those entries is extracted. And, the source IP address 703 and port number 704 in a measurement result are replaced with the transfer source IP address and port number in the extracted relay information, and the destination IP address 705 and port number 706 are replaced with the transfer destination IP address and port number in the relay information. Also the URL 702 is replaced with the transfer destination URL.

In the case where the transfer destination IP address does not coincide with the IP address of the proxy server 108 or the like, then it is judged that the destination is the Web server 105 and the replacement of the addresses and the like is ended.

Thus-converted information is compared with HTTP flows measured in the passive meter 104 of the server side network 112, to extract the information coincident in all of the source IP address and port number, the destination IP address and port number, and the URL. When it is confirmed that there is no other flow coincident in those conditions, then the HTTP flows concerned are judged to be the same HTTP flow.

In the case where there exist a plurality of HTTP flows coincident in those conditions, then the order of the requests is judged based on the transfer times in the relay information of the reverse proxy 109, to identify the same HTTP flows.

As for the HTTP flows judged to be same, a difference is calculated from the request sending times or the first response packet receiving times or the last response packet receiving times in the measurement results, and the calculated difference is a delay time.

Further, in the case where the proxy server 108 or the reverse proxy 109 has a cache function, the cache status 1212 is recorded in the relay information sent to the analysis server 102. The cache status 1212 records “HIT” in the case where, at the time of relaying a request, the proxy server 108 or the like holds the contents of the previous response, and generates a response to send to the client without transferring the request. On the other hand, the cache status 1212 records “MISS” in the case where the contents of the previous response is not held and the request is transferred.

When the analysis unit 503 of the analysis server 102 refers to the relay information of the measurement result database 505 for identifying an HTTP flow, the analysis unit 503 refers to the cache status 1212.

When the cache status 1212 records “MISS”, the request has been transferred. Thus, conversion to the transfer destination address is performed before continuing the above processing.

On the other hand, when the cache status 1212 records “HIT”, the request has not been transferred, and it is judged that the measurement results from the passive meters 104 do not include coincident HTTP flows. And, the address conversion processing for identification of HTTP flows is ended, and the analysis processing is ended judging that a delay time of the HTTP flow is “Nothing”.

As a result, also for HTTP traffic passing through the proxy server 108 and the reverse proxy 109, it is possible to identify an HTTP flow to calculate a delay time, based on measurement results of passive meters 104 arranged at a plurality of locations.

As described above, the present invention provides a measurement system in which an active measurement device and passive measurement devices can cooperate to perform flexible measurement considering a configuration of a Web page. Further, according to the present invention, it is possible to identify an HTTP flow of each content even in the case of Web traffic passing through a relay device, and thus to provide a content measurement system that can perform flexible measurement.

1. A network traffic measurement system comprising:
one or more passive measurement devices, each of which receives packets flowing through a network and performs measurement according to a measurement rule set for that measurement device;
an active measurement device that sends a request for a measurement to a content providing server according to a measurement rule set for said active measurement device, and acquires information relating to contents as measurement objects based on a response to said request for a measurement; and
an analysis device that derives characteristics relating to provision of the contents, by performing calculation according to an analysis rule set for said analysis device, with said calculation using measurement results corresponding to the information acquired by said active measurement device among measurement results of said passive measurement devices.

2. A network traffic measurement system comprising:
one or more passive measurement devices, each of which receives packets flowing through a network and performs measurement according to a measurement rule set for that measurement device;
an active measurement device that sends a request for a measurement to a content providing server according to a measurement rule set for said active measurement device, and acquires information relating to contents as measurement objects based on a response to said request for a measurement; and
an analysis device that derives characteristics relating to provision of the contents, by performing calculation according to an analysis rule set for said analysis device, with said calculation using measurement results corresponding to the information acquired by said active measurement device among measurement results of said passive measurement devices;
wherein:
said active measurement device sets the measurement rule for each of said passive measurement devices, according to said measurement rule set for the active measurement device, and based on said information acquired; and
said active measurement device sets the analysis rule for said analysis device, according to said measurement rule set for the active measurement device.

3. A network traffic measurement system comprising:
one or more passive measurement devices, each of which receives packets flowing through a network and performs measurement according to a measurement rule set for that measurement device;
an active measurement device that sends a request for a measurement to a content providing server according to a measurement rule set for said active measurement device, and acquires information relating to contents as measurement objects based on a response to said request for a measurement;
an analysis device that derives characteristics relating to provision of the contents, by performing calculation according to an analysis rule set for said analysis device, with said calculation using measurement results corresponding to the information acquired by said active measurement device among measurement results of said passive measurement devices; and
a measurement configuration device that sets the measurement rule for said active measurement device based on a measurement request received;
wherein:
said measurement configuration device sets the measurement rule for each of said passive measurement devices and the analysis rule for said analysis device, based on said measurement request and the information acquired by said active measurement device.

4. A network traffic measurement system according to claim 1, wherein:
said request for a measurement sent by said active measurement device to said content providing server includes information on a predetermined attribute;
each of said passive measurement devices records the information on the predetermined attribute included in the request for a measurement; and
when a measurement result of a passive measurement device includes said attribute, said analysis device derives the characteristics relating to the provision of the contents by referring to the information on said attribute.

5. A network traffic measurement system comprising:
one or more passive measurement devices, each of which receives packets flowing through a network between a content providing server and a client, performs measurement according to a measurement rule set for that measurement device, and records a predetermined attribute included in a request sent to the content providing server; and
an analysis device that derives characteristics relating to provision of contents by referring to information of said attribute, with said information being included in measurement results of said passive measurement devices.

6. A network traffic measurement system according to claim 1, further comprising:
a measurement configuration device that sets the respective measurement rules for said passive measurement devices and said active measurement device and sets the analysis rule for said analysis device, based on a measurement request received.

7. A network traffic measurement system according to claim 1, wherein:
said information relating to the contents, which is acquired by said active measurement device, is information for generating a list of URLs (Uniform Resource Locators) of the contents.

8. A network traffic measurement system comprising:
an active measurement device that sends a request for a measurement to a content providing server according to a measurement rule set for the active measurement device;
a relay device that is provided between said active measurement server and said content providing server, and converts and relays information relating to communication;
a plurality of passive measurement devices, each of which receives packets flowing through a network and performs measurement according to a measurement rule for that passive measurement device; and
an analysis device that collects measurement results of said passive measurement devices, identifies a flow as an aggregate of related packets measured in each passive measurement device, and derives traffic characteristics of the network;
wherein:
said analysis device acquires conversion record information that records conversion of the information relating to communication, and identifies a flow based on the acquired conversion record information.

9. A network traffic measurement system comprising:
a relay device that is provided between a client and a content providing server, and converts and relays information relating to communication;
a plurality of passive measurement devices, each of which receives packets flowing through a network and performs measurement according to a measurement rule set for that passive measurement device; and
an analysis device that collects measurement results of said passive measurement devices, identifies a flow as an aggregate of related packets measured in each passive measurement device, and derives traffic characteristics of the network;
wherein:
said analysis device acquires conversion record information that records conversion of the information relating to communication, and identifies a flow based on the acquired conversion record information.
